(19) United States
(12) Patent Application Publication
(10) Pub. No.: US 2011/0164224 A1
(43) Pub. Date: Jul. 7, 2011

(54) VIDEO PROJECTOR

(75) Inventors: Yosuke Nishihata, Hirakata-shi (JP); Satoshi Kitamura, Hirakata-shi (JP)

(73) Assignee: SANYO ELECTRIC CO., LTD., Osaka (JP)

(21) Appl. No.: 12/980,463

(22) Filed: Dec. 29, 2010

(30) Foreign Application Priority Data
Jan. 6, 2010 (JP) 2010-001487

(51) Int. Cl. G03B 21/16

(52) U.S. Cl. 353/31; 353/61; 359/509

(57) ABSTRACT

A video projector including a light source lamp and an optical component having a light transmission plane. A cooling system sends cooling air in parallel currents to the light transmission surface over a predetermined period after the light source lamp goes off to perform auto-cooling on the optical component. A shutter unit includes a planar shutter door that has a planar portion extending parallel to a direction the cooling air flows. The shutter door is moved parallel to the flow direction of the cooling air to open and close an optical path of the optical component. The shutter unit includes a current deflector formed integrally with the shutter door to deflect the flow of the cooling air toward the light transmission surface, and the current deflector directs the cooling air against the light transmission surface of the optical component during the auto-cooling.

### CROSS-REFERENCE TO RELATED APPLICATIONS

This application is based upon and claims the benefit of priority from prior Japanese Patent Application No. 2010-001487, filed on Jan. 6, 2010, the entire contents of which are incorporated herein by reference.

### BACKGROUND OF THE INVENTION

The present invention relates to a video projector, and more particularly, to a mechanism for cleaning optical components such as a liquid crystal panel.

A three-chip LCD video projector known in the prior art includes a dichroic mirror that separates the light emitted from a light source into light components of red, green, and blue, which are the three primary colors. Then, three liquid crystal panels are used to perform light modulation in accordance with an image signal for each color of light. The modulated colors are combined to generate a color image, which is enlarged and projected by a projection lens. Such a video projector has an optical system including components that are susceptible to a rise in temperature, such as a light source lamp, liquid crystal panels, polarization plates, and optical compensation plates. Further, when the temperature of one of such optical components exceeds a tolerable temperature, the image may not be formed properly. Thus, a typical video projector draws in ambient air to cool such optical components with the air.

When cooling is performed as described above, dust may be suspended in the ambient air. When such dust enters the video projector and adheres on an optical component, the dust blocks the penetration of light. The dust may also reflect and diffuse light. This may deteriorate the quality of the projected image. To prevent such a situation, video projectors of the prior art typically include an air filter in an intake opening, through which ambient air is drawn. Nevertheless, particles of dust smaller than the mesh size of the air filter pass through the air filter and collect on optical components such as the liquid crystal panels.

To solve this problem, a cleaning process has been developed, in which compressed air is ejected from an ejection nozzle to blow off dust from the surface of liquid crystal panels. Japanese Laid-Open Patent No. 6-3644 describes such a process.

The video projector may be used with, for example, a personal computer. In this case, the video projector receives an image signal from the personal computer and projects an image. More specifically, a person giving a presentation may operate the personal computer to show an image that is to be presented to the audience on a display of the personal computer. An image that is the same as the image shown on the computer display is enlarged and projected onto a screen by an LCD projector so that the whole audience can see the image. However, when operating the computer, there may be items that the person giving the presentation may wish to hide from the audience. To meet such a demand, a mechanical shutter is used to block the light from the light source lamp. Japanese Laid-Open Patent Publication Nos. 2001-174910, 2002-365607, and 2006-91587 each describe such a shutter. The shutters described in these publications are arranged in an optical path at a location upstream of where the light from the light source lamps is separated into red, green, and blue components or downstream of a location where the light components are combined by the dichroic prism.

Further, in a video projector that uses liquid crystal panels, the light source lamp when illuminated becomes extremely hot. Thus, a cooing fan cools the illuminated light source lamp to prevent overheating. When stopping the projection of an image, the light source lamp is switched off. However, when the cooling fan used for cooling is stopped at the same time, the temperature of the light source lamp may rise and become high. This may adversely affect the life and performance of the light source lamp. Stopping the cooling fan when the light source lamp is switched off may also adversely affect optical components other than the light source lamp, such as the liquid crystal panels. Thus, in a video projector, the cooling fan normally continues to operate for a predetermined time from when the light source lamp is switched off. Then, after the light source lamp and optical components are cooled to a predetermined temperature, the power for the entire projector is switched off. Such a process is referred to as auto-cooling. Japanese Laid-Open Patent Publication Nos. 2006-106639 and 2004-133107 describe such technology.

In the cleaning process described in Japanese Laid-Open Patent Publication No. 6-3644, special equipment, namely, a cylinder containing compressed air and having an ejection nozzle, is necessary to perform the cleaning. When space is limited, it is difficult to install such special equipment. Further, the special equipment increases the cost and size of the projector. Moreover, an operation for opening the ejection nozzle is necessary when dust collects on the optical components, and the cylinder must be exchanged with a new one when the air pressure in the cylinder becomes low. It is difficult to handle such a compressed air cylinder.

Further, the shutters of the prior art described in Japanese Laid-Open Patent Publication Nos. 2001-174910, 2002-365607, and 2006-91587 are just used to temporarily block the projection of an image.

The auto-cooling processes described in Japanese Laid-Open Patent Publication Nos. 2006-106639 and 2004-133107 are just performed to cool the optical components.

In this manner, prior art video projectors are made so that the cleaning function, the shutter function, and the auto-cooling function are all independent functions. Mechanisms for implementing these functions are also formed independently from one another. This is inefficient.

### SUMMARY OF THE INVENTION

One aspect of the present invention is a video projector having a light source lamp and an optical component including a light transmission surface. A cooling system sends cooling air in parallel currents to the light transmission surface of the optical component over a predetermined period after the light source lamp goes off to perform auto-cooling on the optical component. A shutter unit includes a planar shutter door having a planar portion extending parallel to a direction in which the cooling air flows, with the shutter door being moved parallel to the flow direction of the cooling air to open and close an optical path of the optical component. The shutter unit includes a current deflector formed integrally with an upstream end of the shutter door to deflect the flow of the cooling air toward the light transmission surface of the optical component, and the current deflector directs the cooling air against the light transmission surface of the optical component during the auto-cooling.

A further aspect of the present invention is a method for cleaning an optical component in a video projector, with the video projector including a light source lamp, a cooling system that cools the optical component, and a shutter unit that opens and closes an optical path of the optical component. The method includes cooling the optical component by generating a flow of air from the cooling system in a direction orthogonal to the optical path of the optical component over a predetermined period after the light source lamp goes off, operating the shutter unit during the predetermined period after the light source lamp goes off, and directing the air against the optical component during the predetermined period after the light source lamp goes off by deflecting the flow of air from the cooling system with the shutter unit when operating.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram showing optical systems in a video projector according to one embodiment of the present invention;

FIG. 2 is a schematic diagram showing the area near a shutter unit in the video projector of FIG. 1 when an image is projected;

FIG. 3 is a schematic diagram showing the area near the shutter unit in the video projector of FIG. 1 when the shutter is closed;

FIG. 4 is a schematic diagram showing the area near the shutter unit in the video projector of FIG. 1 when auto-cooling is performed;

FIG. 5 is a block diagram of a control circuit in the video projector of FIG. 1; and

FIG. 6 is a timing chart showing a process for controlling the video projector of FIG. 1.

### DETAILED DESCRIPTION OF THE INVENTION

A video projector according to one embodiment of the present invention will now be described with reference to the drawings.

The video projector of one embodiment cleans optical components using the shutter function and auto-cooling function to simplify the mechanisms required to implement the cleaning function, shutter function, and auto-cooling function.

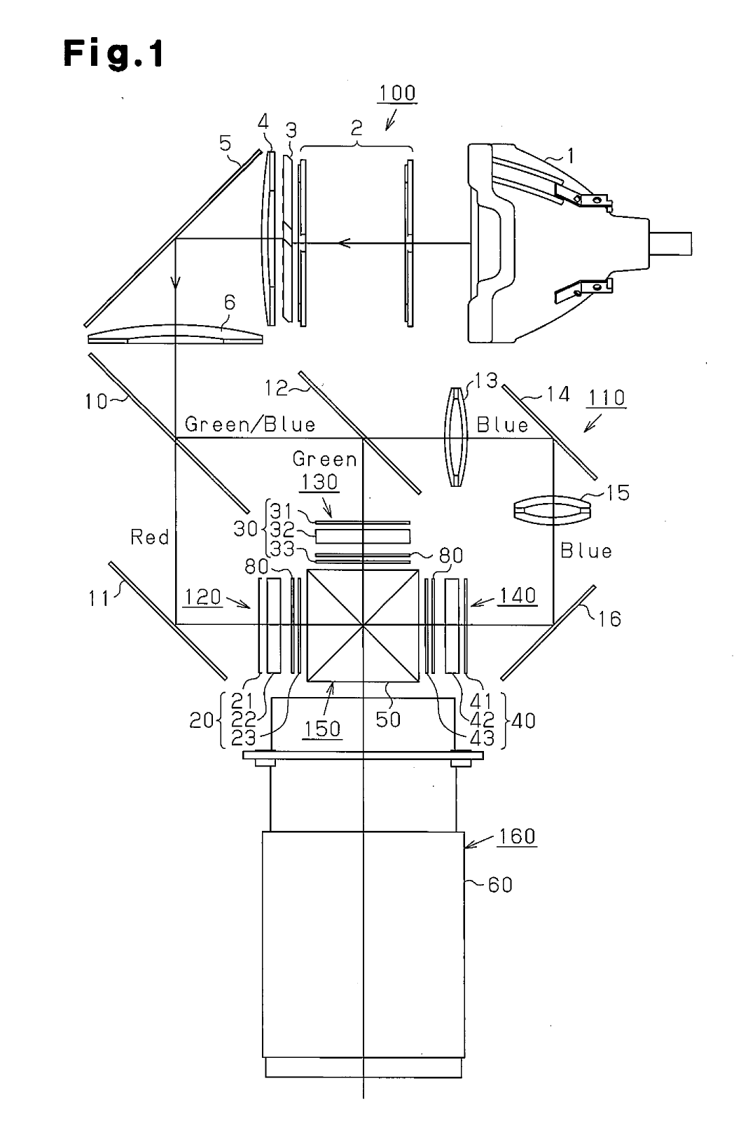

The video projector includes an optical system, which will now be discussed with reference to FIG. 1. The video projector is a so-called three-chip LCD projector and includes an illumination optical system 100 and a color separation optical system 110. The illumination optical system 100 emits illumination light. The color separation optical system 110 separates the illumination light emitted from the illumination optical system 100 into a plurality of colors. Further, the video projector of the present embodiment includes light valves 120, 130, and 140, a color combining optical system 150, and a projection optical system 160. The red, green, and blue components are respectively modulated by the light valves 120, 130, and 140. Then, the light components modulated by the light valves 120, 130, and 140 are combined by the color combining optical system 150. The projection optical system 160 enlarges and projects the combined light emitted from the color combining optical system 150.

The illumination optical system 100 includes a light source lamp 1, an integrator lens 2, a polarizing beam splitter 3, a condenser lens 4, a reflection mirror 5, and a relay lens 6. The light source lamp 1 may be a discharge lamp used as a light emitting body, such as a metal halide lamp or a high pressure mercury-vapor lamp. Further, a reflector produces parallel light from the illumination light, which is emitted from the light source lamp 1. The parallel light travels to the integrator lens 2, the polarizing beam splitter 3, the condenser lens 4, the reflection mirror 5, and the relay lens 6 before striking a first dichroic mirror 10.

The integrator lens 2 includes a pair of lens groups (fly's eye lens), with each lens portion being formed so that the light emitted from the light source lamp 1 is guided to the entire surfaces of the light valves 120, 130, and 140. This homogenizes partial brightness variations in the light emitted from the light source lamp 1 and reduces the difference in the amount of light between the central part and peripheral part of a screen.

The color separation optical system 110 includes dichroic mirrors 10 and 12, reflection mirrors 11, 14, and 16, and relay lenses 13 and 15. The light valves 120, 130, and 140 respectively include a liquid crystal light valve 20 for red light, a liquid crystal light valve 30 for green light, and a liquid crystal light valve 40 for blue light. The color combining optical system 150 includes a cross dichroic prism 50, and the projection optical system 160 includes a projection lens 60, which is formed by a plurality of lenses.

In the color separation optical system 110, the first dichroic mirror 10 passes a red light component while reflecting green and blue light components. This separates the green and blue light components from the red light component. The red light component is guided to the liquid crystal light valve 20 for red light via the reflection mirror 11. The separated green and blue light components are guided to the second dichroic mirror 12, which reflects the green light component and transmits the blue light component. This separates the blue light component from the green light component. The green light component is guided to the liquid crystal light valve 30 for green light. Further, the separated blue light component is guided to the liquid crystal light valve 40 for blue light via the relay lens 13, the reflection mirror 14, the relay lens 15, and the reflection mirror 16.

The liquid crystal light valves 20, 30, and 40 for red, green, and blue lights respectively include entrance side polarization plates 21, 31, and 41, liquid crystal panels 22, 32, and 42 serving as light modulation elements, and exit side polarization plates 23, 33, and 43. The red, green, and blue lights modulated by the liquid crystal light valves 20, 30, and 40 are combined by the cross dichroic prism 50 and emitted to the projection lens 60.

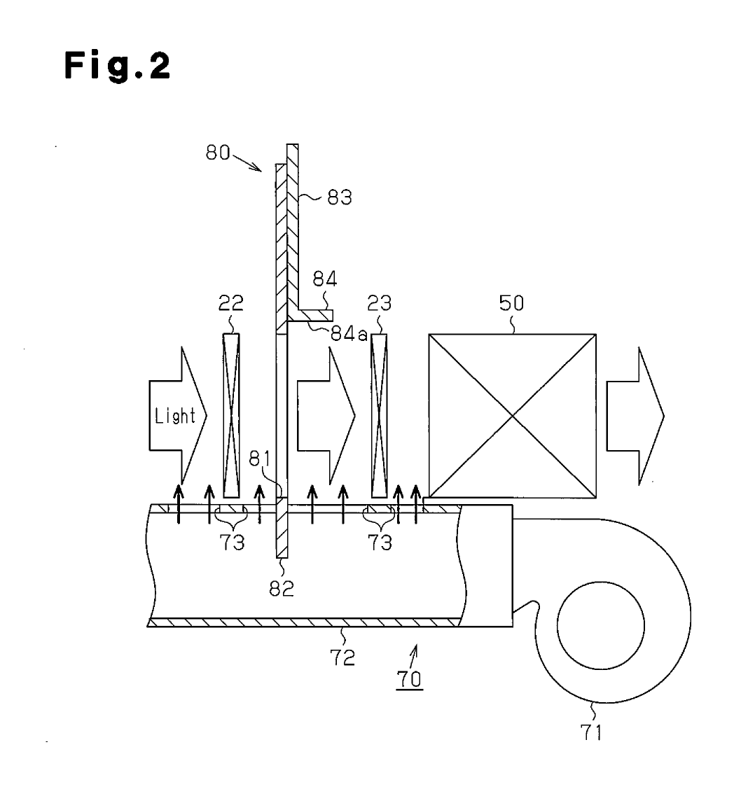

An optical system such as that described above includes optical components other than the light source lamp 1 having upper tolerable temperatures that are relatively low. Such optical components may be represented by the optical components of the liquid crystal light valves 20, 30, and 40 for each colored light. Thus, as shown in FIG. 2, a cooling system 70 is used to send an air current and cool the optical components of the liquid crystal light valves 20, 30, and 40.

The video projector includes a shutter function. The liquid crystal light valves 20, 30, and 40 each arrange a shutter unit 80 between the corresponding liquid crystal panels 22, 32, and 42 and exit side polarization plates 23, 33, and 43.

The cooling system 70 and shutter unit 80 arranged in the liquid crystal light valve 20 for red light will now be described with reference to FIGS. 2 to 4. In the other liquid crystal light valves 30 and 40, the cooling system 70 and shutter unit 80 are arranged in the same manner and thus will not be described.

The cooling system 70 includes a cooling fan 71, a duct 72, and outlets 73. The cooling fan 71 is formed by a sirocco fan and draws air into the projector. The duct 72 is arranged under the optical components that are subject to cooling, namely, the liquid crystal panel 22 and the exit side polarization plate 23. The air drawn into the duct 72 by the cooling fan 71 is blown out of the outlets 73 as parallel air currents and directed upward toward light transmission planes of the liquid crystal panel 22 and the exit side polarization plate 23. This cools the optical components.

The shutter unit 80 is arranged in a separated-light optical path, through which the light that has undergone color separation travels, between the liquid crystal panel 22 and the exit side polarization plate 23. Further, the shutter unit 80 includes a frame 82, a planar shutter door 83, and a driver (not shown), which drives the shutter door 83. The frame 82 defines an opening 81 having a central portion through which the optical path extends. The shutter door 83 is planar and includes a planar portion that opens and closes the opening 81 of the frame 82. This opens and closes the optical path. The shutter door 83 moves in the direction cooling air flows (i.e., the vertical direction as viewed in FIG. 2) along a plane orthogonal to the optical path. This opens and closes the opening 81.

The shutter door 83 has an end located at the upstream side relative to the flow of cooling air. A current deflector 84 is formed integrally with upstream end of the shutter door 83. The current deflector 84 deflects the flow of cooling air toward the light transmission planes of the optical components. The current deflector 84 and the shutter door 83 are formed integrally by an L-shaped heat-resistant resin plate or metal plate. A black light absorption agent is applied to the surfaces of the current deflector 84 and shutter door 83 to absorb the received light. The current deflector 84 has an upstream surface 84a that is orthogonal to the light transmission surfaces of the optical components, namely, the liquid crystal panel 22 and the exit side polarization plate 23. This deflects the air flow so that the cooling air is blown against the optical components.

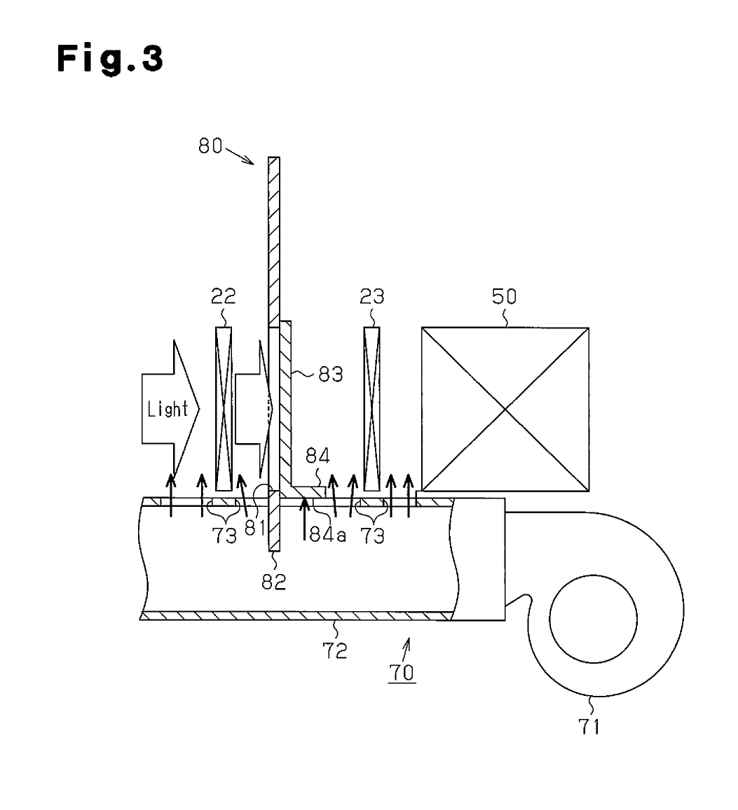

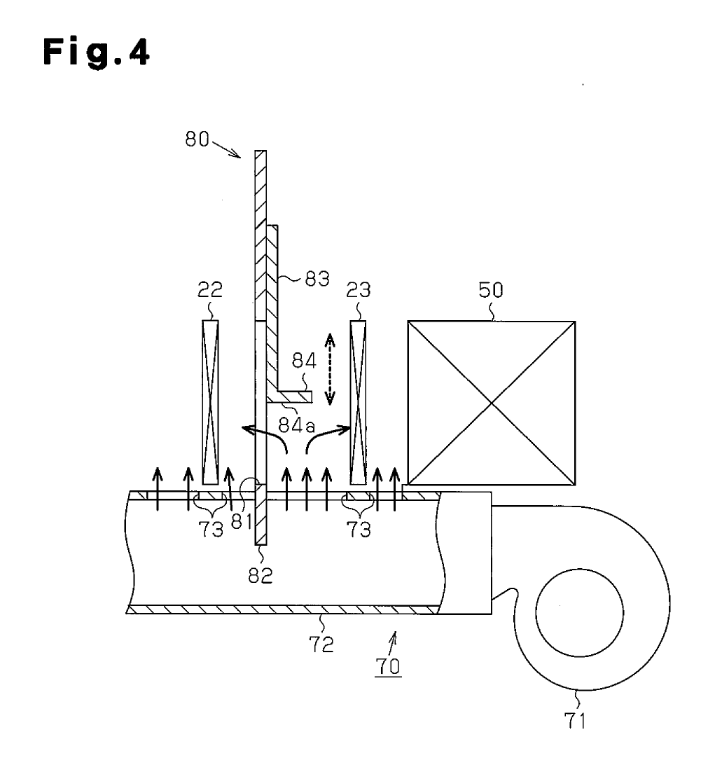

FIGS. 2 to 4 show the movement of the shutter unit 80. FIG. 2 shows a state in which the shutter unit 80 is open during operation of the video projector. FIG. 3 shows a state in which the shutter function is active during operation of the video projector. FIG. 4 shows a state in which auto-cooling is being performed after stopping operation of the video projector. During the auto-cooling, as indicated by the arrows on the broken line, the shutter unit 80 is controlled to repetitively reciprocate (move in the opening and closing directions) in the flow direction of the cooling air (vertical direction as viewed in FIGS. 2 and 4). As a result, the cooling air blown out of the outlets 73 strikes the current deflector 84 and is directed toward the light transmission surfaces of the optical components as shown by the arrows on the solid lines. Further, the vertical movement (opening and closing) of the shutter door 83 in the shutter unit 80, as indicated by the arrows on the broken line in FIG. 4, blows the cooling air entirely against the light transmission surfaces.

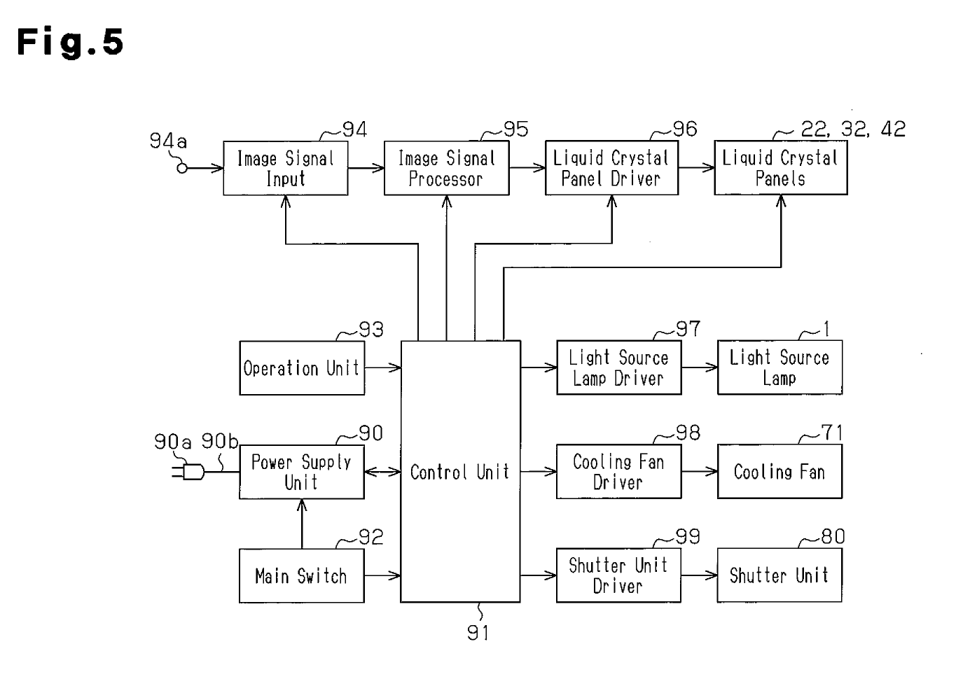

The video projector the present embodiment includes a control circuit. Referring to FIG. 5, the control circuit includes a power supply unit 90, a control unit 91, a main switch 92, and an operation unit 93, which are the basic devices required to start operation.

The power supply unit 90 is connected to an external socket 90a of a commercial power supply by a power cord 90b. The power supply unit 90 converts the voltage and frequency of the commercial power into a voltage and frequency applicable to internal circuits of the projector.

The control unit 91, which exchanges signals with other units and controls each unit so that the video projection functions properly, includes a microprocessor incorporating a ROM, RAM, and the like. The ROM stores control programs, necessary constants, and the like.

A user uses the main switch 92 to switch the video projector on and off between an operation state and a stoppage state. More specifically, when the power supply unit 90 is connected to the commercial power supply by the power cord 90b, the power supply unit 90 is constantly active. In this state, by switching on the main switch 92, the power supply unit 90 supplies the entire video projector with power to enter the operation state.

The user uses the operation unit 93 to perform operations other than the power on/off operations. For example, the operation unit 93 is used to adjust the size, tone, focus, and keystone of a projected image. The operation unit 93 also allows for adjustment of the movement of the shutter unit 80 and the time for auto-cooling taking into consideration the level at which dust elimination should be performed.

Referring to FIG. 5, in the video projector of the present embodiment, the control circuit includes an image signal input 94, an image signal processor 95, a liquid crystal panel driver 96, a light source lamp driver 97, a cooling fan driver 98, and a shutter unit driver 99. These are the elements used to project an image.

The image signal input 94 receives image signals from various types of image reproduction devices through an input terminal 94a. Further, the image signal input 94 includes input interfaces, such as an analog I/F, a digital I/F, and a video I/F, so as to be applicable to various types of image signals from various image reproduction devices, such as an analog PC, a digital PC, a video device, and a television. The image signal input 94 receives a main image signal. The main image signal undergoes the necessary processes such as A/D conversion and decoding. This converts the main image signal to a digital signal, which is output to the image signal processor 95.

The image signal processor 95 performs typical processes on the input image signal, such as a scaling process, gamma correction, and brightness correction. An image signal that has undergone such processing is output to the liquid crystal panel driver 96.

The liquid crystal panel driver 96 converts the image signal into a signal format capable of driving the liquid crystal panels 22, 32, and 42 for the red, green, and blue lights. Further, the liquid crystal panel driver 96 simultaneously generates drive pulses that drive the liquid crystal panels 22, 32, and 42 for the red, green, and blue lights. The liquid crystal panels 22, 32, and 42 transmit the light from the color separation optical system at a rotational angle that is in accordance with the input image signal to generate an image.

The light source lamp driver 97 includes an igniter circuit and a ballast circuit. The igniter circuit, which serves as a discharge circuit, is supplied with power from the power supply unit 90 and generates high voltage to illuminate the light source lamp 1. Subsequent to illumination of the light source lamp 1, the ballast circuit maintains a stable illumination state.

The cooling fan driver 98 is a circuit that controls the operation of the cooling fan 71 for cooling the optical components and a further cooling fan (not shown) for cooling the light source lamp 1.

The shutter unit driver 99 closes the shutter door 83 when receiving an instruction from the operation unit 93 to operate the shutter unit 80 via the control unit 91. When an instruction for stopping operation is issued from the main switch 92, the control unit 91 controls the shutter unit driver 99 to repetitively open and close the shutter door 83 a predetermined number of times by moving the shutter door 83 upward and downward during a cooling off period. An actuator (not shown), such as a solenoid, may be used as a device for driving the shutter unit 80.

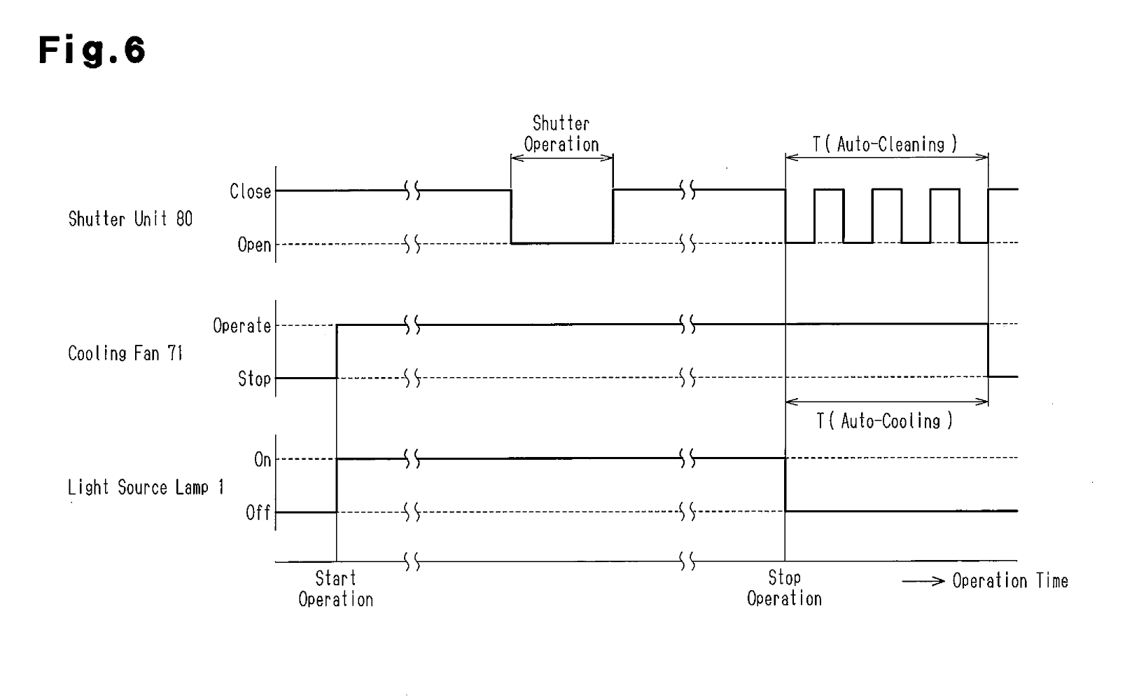

The video projector is controlled as shown by the timing chart in FIG. 6.

First, the main switch 92 is operated to switch on the power. This illuminates the light source lamp 1 and drives the cooling fan 71. Accordingly, illumination light is emitted, and the cooling fan 71 sends an air current to the optical components. Although not shown in the drawings, air serving as a cooling medium is also sent to the light source lamp 1 and the polarizing beam splitter 3. In this state, the shutter units 80 continuously remain in an open state as they have been during operation stoppage of the projector.

After operation of the projector continues for a predetermined time, when the operation unit 93 is operated to activate the shutter function, such as when switching images, the shutter units 80 arranged in the liquid crystal light valves 20, 30, and 40 are operated to close the shutter doors 83. The shutter doors 83 continuously remain closed until the operation unit 93 is operated to deactivate the shutter function.

When image projection ends and operation of the projector is stopped by the main switch 92, that is, when the power is switched off, the light source lamp 1 goes off. When stopping operation of the cooling fan 71 at the same time, the temperature of the light source lamp 1 and optical components may increase and exceed the tolerable limit. Thus, the cooling fan 71 continues to operate for a while (predetermined time T). Such operation is referred to as auto-cooling.

Fine particles of dust, which are suspended in the cooling air, may collect on the light transmission surfaces of the optical components. To eliminate dust from the light transmission surfaces of the liquid crystal panels 22, 32, and 42 and the exit side polarization plates 23, 33, and 43, which are located near the focal point of the projection lens 60, the shutter door 83 of each shutter unit 80 is repetitively opened and closed in the direction in which cooling air flows (vertical direction as viewed in FIG. 4 and indicated by the arrows on the broken line).

When the shutter door 83 moves, the cooling air blown out of the outlets 73, which is located under the optical components, strikes the upstream surface 84a of the current deflector 84 in the corresponding shutter unit 80. This deflects the cooling air blown out of the outlets 73 toward the light transmission surfaces of the optical components. As a result, dust is blown off the light transmission surfaces of the optical components and sent out of the projector. In this manner, the present embodiment performs a cleaning operation whenever operation is stopped. This is referred to as the auto-cleaning function of the video projector.

The video projector of the present embodiment has the advantages described below.

(1) The video projector of the present embodiment sends parallel currents of cooling air to the light transmission surfaces of optical components for a predetermined time after the light source lamp 1 goes off to perform auto-cooling.

(2) The current deflector 84, which deflects the flow of cooling air toward the light transmission surfaces of the optical components, is formed integrally with the upstream end of the shutter door 83. During auto-cooling, the current deflector 84 directs the cooling air toward the light transmission surfaces of the optical components. Accordingly, during auto-cooling, the optical components and the shutter unit 80 are both cooled by the same cooling air. Further, the cooling effect of the optical components is increased during auto-cooling. Moreover, whenever auto-cooling is performed, the cooling air is blown against the light transmission surfaces of the optical components to eliminate dust from the light transmission surfaces. This ensures that cleaning is performed and obtains high-quality images.

(3) The cooling air for performing auto-cleaning on the optical components is used to cool the shutter units 80. The cooling air is also used for cleaning. This simplifies the overall projector.

(4) The shutter unit 80 is formed so that the upstream surface 84a of the current deflector 84 is orthogonal to the light transmission surfaces of the liquid crystal panel 22 and exit side polarization plate 23. Thus, the cooling air is strongly blown against the light transmission surfaces of the optical components. This efficiently eliminates dust from the light transmission surfaces of the optical components.

(5) The shutter door 83 and current deflector 84 are formed by bending a plate into an L-shape. Thus, the shutter door 83 is easily formed.

(6) The shutter door 83 of the shutter unit 80 is repetitively moved to open and close during auto-cooling. Thus, cooling air is repetitively blown against the entire light transmission surface of each optical component. This blows off dust from the entire light transmission surface of the optical component and prevents image deterioration.

(7) In each shutter unit 80, the driving direction for implementing the shutter function is the same as the driving direction for implementing the cooling function. This allows for the shutter function and the cooling function to be implemented with the same drive mechanism. In this manner, the shutter unit 80 does not require a special driving mechanism. This simplifies the structure of shutter unit 80.

(8) The shutter unit 80 is arranged in the optical path for each color component of light that has undergone color separation. Thus, the shutter unit 80 blocks light that has undergone light separation. This decreases the thermal load applied to each shutter unit 80 and simplifies cooling.

(9) The shutter units 80 are arranged between the corresponding liquid crystal panels 22, 32, and 42 and exit side polarization plates 23, 33, and 43. Thus, the cooling air used to cool the optical components, which require cooling most, is used for cleaning. This increases the amount of air used for cleaning and increases the cleaning effect. Further, cleaning is ensured for the liquid crystal panels 22, 32, and 42 and exit side polarization plates 23, 33, and 43, which are most easily affected by dust. This increases the effect of preventing image deterioration, which would be caused by dust.

It should be apparent to those skilled in the art that the present invention may be embodied in many other specific forms without departing from the spirit or scope of the invention. Particularly, it should be understood that the present invention may be embodied in the following forms.

In the above-described embodiment, the shutter door 83 is repetitively opened and closed during auto-cleaning. However, the shutter door 83 only needs to be opened and closed at least once during the period in which auto-cleaning is performed. In this case, the shutter door 83 may be slowly closed during the former half of the auto-cleaning period and slowly opened during the latter half of the auto-cleaning period.

In the above-described embodiment, the shutter door 83 and current deflector 84 may be formed by bending a metal plate. Alternatively, the shutter door 83 and current deflector 84 may be an L-shaped molded product formed from a heat-resistant resin material. Further, instead of being L-shaped, the shutter door 83 and current deflector 84 may be T-shaped.

The current deflector 84 need only be formed so that at least a distal portion of the upstream surface 84a is orthogonal to the light transmission surfaces of the optical components (i.e., the liquid crystal panel 22 and exit side polarization plate 23). Thus, the current deflector 84 may be modified in the following manner. The current deflector 84 may be formed so that the angle between the upstream surface 84a, which is located at the edge of the current deflector 84, and the light transmission surfaces of the optical components is an acute angle. Such a structure also strongly blasts cooling air against the light transmission surfaces of the optical components. Further, the current deflector 84 may be formed so that most of the upstream surface 84a is arranged at a right angle or acute angle relative to the light transmission surfaces of the optical components. The current deflector 84 may also include a guide formed at the central portion of the upstream surface 84a so that the cooling air is dispersed at appropriate flow rates toward the liquid crystal panels 22, 32, and 42 and the exit side polarization plates 23, 33, and 43.

Further, in the above-discussed embodiment, the location of the shutter unit 80 may be changed. For example, the shutter unit 80 may be arranged in an optical path in front of where color separation is performed such as between the polarizing beam splitter 3 and the integrator lens 2. In this case, however, when the shutter function is implemented, there would be a drawback in that the increase in the temperature of the shutter unit 80 is large.

The shutter unit 80 may also be arranged in an optical path behind where color separation is performed. In such a case, the increase in the temperature of the shutter unit 80 would be kept low when the shutter function is implemented. Further, when blocking the optical path, an increase in temperature of the optical components located behind the shutter unit 80 is prevented, deterioration of the optical components is prevented, and the life of the optical components is prolonged.

The shutter units 80 may be arranged at any location in the liquid crystal light valves 20, 30, and 40. For example, the shutter units 80 may be arranged between the entrance side polarization plates 21, 31, and 41 and the liquid crystal panels 22, 32, and 42.

The present examples and embodiments are to be considered as illustrative and not restrictive, and the invention is not to be limited to the details given herein, but may be modified within the scope and equivalence of the appended claims.

What is claimed is:

1. A video projector comprising:
a light source lamp;
an optical component including a light transmission surface;
a cooling system that sends cooling air in parallel currents to the light transmission surface of the optical component over a predetermined period after the light source lamp goes off to perform auto-cooling on the optical component; and
a shutter unit including a planar shutter door having a planar portion extending parallel to a direction in which the cooling air flows, with the shutter door being moved parallel to the flow direction of the cooling air to open and close an optical path of the optical component, wherein the shutter unit includes a current deflector formed integrally with an upstream end of the shutter door to deflect the flow of the cooling air toward the light transmission surface of the optical component, and the current deflector directs the cooling air against the light transmission surface of the optical component during the auto-cooling.

2. The video projector according to claim 1, wherein
the current deflector has an end defining an upstream surface; and
the shutter unit is formed so that the angle between the upstream surface of the current deflector and the light transmission surface of the optical component is a right angle or an acute angle.

3. The video projector according to claim 2, wherein the shutter door and the current deflector are formed by an L-shaped plate.

4. The video projector according to claim 1, wherein the shutter unit repetitively opens and closes the shutter door during the auto-cooling.

5. The video projector according to claim 1, wherein the current deflector is shaped to disperse the flow of the cooling air in two directions extending along the optical path.

6. The video projector according to claim 1, wherein
the optical component is one of a plurality of optical components arranged in the video projector; and
the shutter unit is arranged between two of the optical components.

7. The video projector according to claim 1, wherein the optical component is a light valve.

8. The video projector according to claim 1, further comprising:
an illumination optical system that emits illumination light and includes the light source lamp;
a color separation optical system that separates the illumination light emitted from the illumination optical system into red, green, and blue light components;
a plurality of light valves that respectively modulate the red, green, and blue light components;
a color combining optical system that combines the light components modulated by the light valves; and
a projection optical system that enlarges and projects the combined light emitted from the color combining optical system;
wherein the shutter unit is one of a plurality of shutter units; and
the shutter units are arranged in separate paths of the light components, respectively.

9. The video projector according to claim 8, wherein the shutter units are arranged in the immediately downstream of the color separation optical system in the respective separate paths.

10. The video projector according to claim 8, wherein each of the light valves is a liquid crystal light valve including an entrance side polarization plate, a liquid crystal panel, and an exit side polarization plate; and
the shutter units are arranged in the liquid crystal light valves between the entrance side polarization plate and the exit side polarization plate, respectively.

11. A method for cleaning an optical component in a video projector, with the video projector including a light source lamp, a cooling system that cools the optical component, and a shutter unit that opens and closes an optical path of the optical component, the method comprising:
cooling the optical component by generating a flow of air from the cooling system in a direction orthogonal to the optical path of the optical component over a predetermined period after the light source lamp goes off;
operating the shutter unit during the predetermined period after the light source lamp goes off; and
directing the air against the optical component during the predetermined period after the light source lamp goes off by deflecting the flow of air from the cooling system with the shutter unit when operating.

12. The method according to claim 11, wherein the directing of the air against the optical component includes directing the air entirely against a light transmission surface of the optical component with the shutter unit when operating.

13. The method according to claim 11, wherein the directing of the air against the optical component includes dispersing the flow of air from the cooling system in two directions along the optical path with the shutter unit when operating.

14. The method according to claim 11, wherein the operating of the shutter unit during the predetermined period includes opening and closing the optical path of the optical component at least once with the shutter unit.

15. The method according to claim 11, wherein the operating of the shutter unit during the predetermined period includes repetitively opening and closing the optical path of the optical component with the shutter unit.
